(19) United States
(12) Patent Application Publication
(10) Pub. No.: US 2026/0269902 A1
(43) Pub. Date: Sep. 10, 2026

(54) DEVICE AND METHOD FOR CONFIGURING CSI-RS FOR NARROWBAND COMMUNICATION IN WIRELESS COMMUNICATION SYSTEM

(71) Applicant: LG Electronics Inc., Seoul (KR)

(72) Inventors: Jaehyung KIM, Seoul (KR); Seungjin AHN, Seoul (KR); Suckchel YANG, Seoul (KR); Sunghoon LEE, Seoul (KR)

(21) Appl. No.: 19/157,084

(22) PCT Filed: Feb. 16, 2024
(86) PCT No.: PCT/KR2024/095337

§ 371 Date: Aug. 15, 2025

(30) Foreign Application Priority Data
Feb. 16, 2023 (KR) 10-2023-0021055

(51) Int. Cl. H04B 7/06; H04W 76/40

(52) U.S. Cl. CPC H04B 7/0626; H04W 76/40

(57) ABSTRACT

According to various embodiments of the present disclosure, there is provided a method of operating a user equipment (UE) in a wireless communication system, the method including determining a size of a first bandwidth part (BWP) for a channel state information reference signal (CSI-RS) or a tracking reference signal (TRS) within a channel bandwidth less than 5 MHz, for the CSI-RS, the first BWP being based on a minimum value among a maximum transmit bandwidth (max Tx BW) and 24 physical resource blocks (PRBs), for the TRS, the first BWP being based on a minimum value among the max Tx BW and 52 PRBs; and receiving the CSI-RS or the TRS from a base station (BS) within the first BWP.

### TECHNICAL FIELD

The present disclosure relates to a wireless communication system. More particularly, the present disclosure relates to a device and method for configuring CSI-RS for narrowband communication in a wireless communication system.

### BACKGROUND ART

In order to efficiently support various use cases (e.g., IoT, wearable, etc.) in 5G in terms of cost/complexity, types of terminals with reduced cost/complexity are being introduced. Newly introduced types of terminals may reduce their maximum supported bandwidth and may not be able to receive all synchronization signal blocks (SSBs).

There is a demand from operators to apply the 5G NR system to wireless communication for railway, utility/infrastructure network, public safety, etc. using the existing narrowband spectrum (<5 MHz). Reflecting these requirements, standardization work is underway in Rel-18 to support bandwidths (e.g., −3 MHz) less than 5 MHz in the NR system.

### DISCLOSURE

### Technical Problem

In order to solve the above-described problems, the present disclosure provides a device and method for configuring CSI-RS for narrowband communication in a wireless communication system.

The present disclosure provides a device and method for contributing to the expansion of application use cases of NR systems by solving problems that may occur when supporting a narrowband terminal/spectrum scenario in a wireless communication system.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

According to various embodiments of the present disclosure, there is provided a method of operating a user equipment (UE) in a wireless communication system, the method comprising determining a size of a first bandwidth part (BWP) for a channel state information reference signal (CSI-RS) or a tracking reference signal (TRS) within a channel bandwidth less than 5 MHz, for the CSI-RS, the first BWP being based on a minimum value among a maximum transmit bandwidth (max Tx BW) and 24 physical resource blocks (PRBs), for the TRS, the first BWP being based on a minimum value among the max Tx BW and 52 PRBs; and receiving the CSI-RS or the TRS from a base station (BS) within the first BWP.

According to various embodiments of the present disclosure, there is provided a method of operating a base station in a wireless communication system, the method comprising determining a size of a first bandwidth part (BWP) for a channel state information reference signal (CSI-RS) or a tracking reference signal (TRS) within a channel bandwidth less than 5 MHz, for the CSI-RS, the first BWP being based on a minimum value among a maximum transmit bandwidth (max Tx BW) and 24 physical resource blocks (PRBs), for the TRS, the first BWP being based on a minimum value among the max Tx BW and 52 PRBs; and transmitting the CSI-RS or the TRS to a user equipment (UE) within the first BWP.

According to various embodiments of the present disclosure, there is provided a user equipment (UE) in a wireless communication system, the UE comprising a transceiver, at least one processor, and at least one memory operably connectable to the at least one processor and storing instructions performing operations based on being executed by the at least one processor, wherein the operations comprise all steps of a method of operating the UE according to various embodiments of the present disclosure.

According to various embodiments of the present disclosure, there is provided a base station in a wireless communication system, the base station comprising a transceiver, at least one processor, and at least one memory operably connectable to the at least one processor and storing instructions performing operations based on being executed by the at least one processor, wherein the operations comprise all steps of a method of operating the base station according to various embodiments of the present disclosure.

According to various embodiments of the present disclosure, there is provided a control device controlling a user equipment (UE) in a wireless communication system, the control device comprising at least one processor and at least one memory operably connectable to the at least one processor, wherein the at least one memory stores instructions performing operations based on being executed by the at least one processor, and the operations comprise all steps of a method of operating the UE according to various embodiments of the present disclosure.

According to various embodiments of the present disclosure, there is provided a control device controlling a base station in a wireless communication system, the control device comprising at least one processor and at least one memory operably connectable to the at least one processor, wherein the at least one memory stores instructions performing operations based on being executed by the at least one processor, and the operations comprise all steps of a method of operating the base station according to various embodiments of the present disclosure.

According to various embodiments of the present disclosure, there are provided one or more non-transitory computer readable mediums storing one or more instructions, wherein the one or more instructions perform operations based on being executed by one or more processors, and the operations comprise all steps of a method of operating a user equipment (UE) according to various embodiments of the present disclosure.

According to various embodiments of the present disclosure, there are provided one or more non-transitory computer readable mediums storing one or more instructions, wherein the one or more instructions perform operations based on being executed by one or more processors, and the operations comprise all steps of a method of operating a base station according to various embodiments of the present disclosure.

### Advantageous Effects

In order to solve the above-described problems, the present disclosure can provide a device and method for configuring CSI-RS for narrowband communication in a wireless communication system.

The present disclosure can provide a device and method for contributing to the expansion of application use cases of NR systems by solving problems that may occur when supporting a narrowband terminal/spectrum scenario in a wireless communication system.

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description. Technical features of the present disclosure are not limited to specific drawings, and features disclosed in each drawing can be combined with each other to form a new embodiment. Reference numerals in each drawing may denote structural elements.

FIG. 1 illustrates physical channels used in a system applicable to the present disclosure and an example of a general signal transmission method using the physical channels.

FIG. 2 illustrates an example of a structure of a radio frame used in a system applicable to the present disclosure.

FIG. 3 illustrates an example of a slot structure used in a system applicable to the present disclosure.

FIG. 4 illustrates an example of a slot structure of a radio frame used in a system applicable to the present disclosure.

FIG. 5 illustrates an example of time/frequency structure of a synchronization signal block (SSB) in a system applicable to the present disclosure.

FIG. 6 illustrates an example of an operation process of a UE in a system applicable to the present disclosure.

FIG. 7 illustrates an example of an operation process of a base station in a system applicable to the present disclosure.

FIG. 8 illustrates an example of a structure of a first device and a second device in a system applicable to the present disclosure.

### MODE FOR INVENTION

In various embodiments of the present disclosure. “A or B” may mean “only A,” “only B” or “both A and B.” In other words, in various embodiments of the present disclosure, “A or B” may be interpreted as “A and/or B.” For example, in various embodiments of the present disclosure, “A. B or C” may mean “only A,” “only B,” “only C” or “any combination of A. B and C.”

A slash (/) or comma used in various embodiments of the present disclosure may mean “and/or.” For example, “A/B” may mean “A and/or B.” Hence, “A/B” may mean “only A,” “only B” or “both A and B.” For example. “A, B, C” may mean “A, B, or C.”

In various embodiments of the present disclosure, “at least one of A and B” may mean “only A,” “only B” or “both A and B.” In addition, in various embodiments of the present disclosure, the expression of “at least one of A or B” or “at least one of A and/or B” may be interpreted in the same meaning as “at least one of A and B.”

Further, in various embodiments of the present disclosure, “at least one of A. B. and C” may mean “only A,” “only B,” “only C” or “any combination of A. B and C.” In addition, “at least one of A, B or C” or “at least one of A, B and/or C” may mean “at least one of A, B, and C.”

Further, parentheses used in various embodiments of the present disclosure may mean “for example.” Specifically, when “control information (PDCCH)” is described, “PDCCH” may be proposed as an example of “control information.” In other words, “control information” in various embodiments of the present disclosure is not limited to “PDCCH,” and “PDDCH” may be proposed as an example of “control information.” In addition, even when “control information (i.e., PDCCH)” is described, “PDCCH” may be proposed as an example of “control information.”

Technical features described individually in one drawing in various embodiments of the present disclosure may be implemented individually or simultaneously.

### General Signal Transmission Method in 3GPP

### Physical Channels and General Signal Transmission

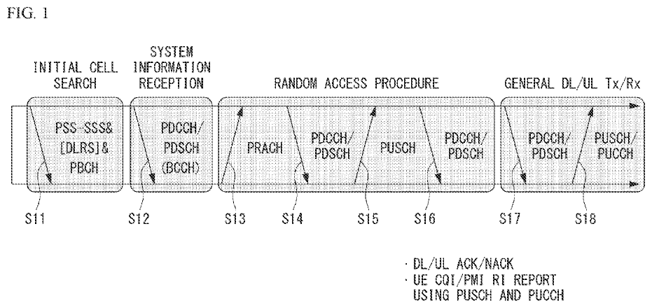

FIG. 1 illustrates physical channels used in a system applicable to the present disclosure and an example of a general signal transmission method using the physical channels. More specifically, FIG. 1 illustrates physical channels and general signal transmission used in the 3GPP system.

FIG. 1 illustrates physical channels and general signal transmission used in the 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

A UE that is powered on again while being powered off or enters a new cell performs an initial cell search operation such as synchronizing with a base station (BS) in S11. To this end, the UE receives a primary synchronization channel (PSCH) and a secondary synchronization channel (SSCH) from the base station to synchronize with the base station and acquires information such as a cell identity (ID), etc. Further, the UE may receive a physical broadcast channel (PBCH) from the base station and acquire in-cell broadcast information. The UE may receive a downlink reference signal (DL RS) in an initial cell search step to check a downlink channel state.

The UE that completes the initial cell search may receive a physical downlink control channel (PDCCH) and a physical downlink shared channel (PDSCH) corresponding to the PDCCH to acquire more detailed system information, in S12.

Next, the UE may perform a random access procedure in order to complete an access to the base station, in S13 to S16. Specifically, the UE may transmit a preamble on a physical random access channel (PRACH) in S13, and receive a random access response (RAR) for the preamble on the PDCCH and the PDSCH corresponding to the PDCCH in S14. Thereafter, the UE may transmit a physical uplink shared channel (PUSCH) using scheduling information within the RAR in S15, and perform a contention resolution procedure such as the PDCCH and the PDSCH corresponding to the PDCCH in S16.

Next, the UE that performs the above-described procedure may perform PDCCH/PDSCH reception S17 and PUSCH/physical uplink control channel (PUCCH) transmission S18, as a general uplink/downlink signal transmission procedure. Control information that the UE transmits to the base station is referred to as uplink control information (UCI). The UCI includes hybrid automatic repeat and request (HARQ) acknowledgement/negative ACK (ACK/NACK), scheduling request (SR), channel state information (CSI), etc. The CSI includes a channel quality indication (CQI), a precoding matrix indicator (PMI), a rank indicator (RI), etc. The UCI is generally transmitted on the PUCCH, but if control information and data need to be transmitted at the same time, the UCI may be transmitted on the PUSCH. The UE may aperiodically transmit the UCI on the PUSCH based on a request/indication of the network.

### Orthogonal Frequency Division Multiplexin (OFDM) Numerology

A new RAT system uses an OFDM transmission scheme or a similar transmission scheme thereto. The new RAT system may follow different OFDM parameters from OFDM parameters of LTE. Alternatively, the new RAT system may follow numerology of existing LTE/LTE-A as it is but have a larger system bandwidth (e.g., 100 MHz). Alternatively, one cell may support a plurality of numerologies. In other words, UEs that operate with different numerologies may coexist in one cell.

### Radio Frame Structure

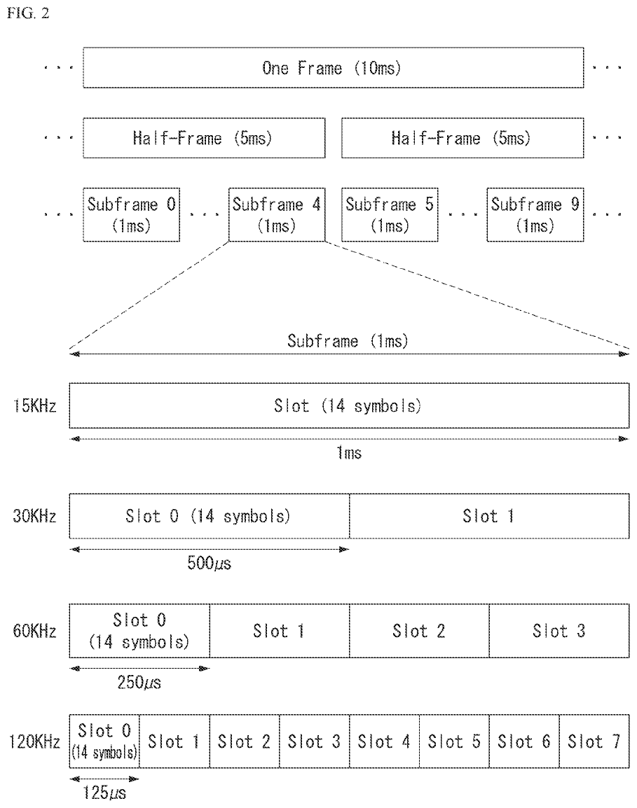

FIG. 2 illustrates an example of a structure of a radio frame used in a system applicable to the present disclosure.

In NR, uplink and downlink transmission consists of frames. A radio frame has a length of 10 ms and is defined as two 5 ms half-frames (HFs). The half-frame is defined as five 1 ms subframes (SFs). The subframe is split into one or more slots, and the number of slots in the subframe depends on a subcarrier spacing (SCS). Each slot includes 12 or 14 OFDM(A) symbols depending on a cyclic prefix (CP). When a normal CP is used, each slot includes 14 symbols. When an extended CP is used, each slot includes 12 symbols. The symbol may include an OFDM symbol (or CP-OFDM symbol) and an SC-FDMA symbol (or DFT-s-OFDM symbol).

Table 1 shows that when the normal CP is used, the number of symbols per slot, the number of slots per frame, and the number of slots per subframe vary depending on the SCS.

TABLE 1

| SCS (15*2\hat{ }u) | N^{slot}_{symb} | N^{frame,u}ₛₗₒₜ | N^{subframe,u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

N^{slot}_{symb} is the number of symbols in the slot. N^{frame,u}ₛₗₒₜ is the number of slots in the frame. N^{subframe,u}ₛₗₒₜ is the number of slots in the subframe.

Table 2 shows that when the extended CP is used, the number of symbols per slot, the number of slots per frame, and the number of slots per subframe vary depending on the SCS.

TABLE 2

| SCS (15*2\hat{ }u) | N^{slot}_{symb} | N^{frame,u}ₛₗₒₜ | N^{subframe,u}ₛₗₒₜ |
|---|---|---|---|
| 60 KHz (u = 2) | 12 | 40 | 4 |

The NR supports multiple numerologies (or subcarrier spacing (SCS)) for supporting various 5G services. For example, when the SCS is 15 kHz, a wide area in traditional cellular bands is supported, when the SCS is 30 kHz/60 kHz, dense-urban, lower latency, and wider carrier bandwidth are supported, and when the SCS is 60 kHz or more, a bandwidth larger than 24.25 GHz is supported to overcome phase noise.

An NR frequency band may be defined as two types of frequency ranges (FR1 and FR2). Values of the frequency ranges may be changed, and, for example, the two types of frequency ranges (FR1 and FR2) may be as shown in Table 3 below. For convenience of description, among frequency ranges used in an NR system. FR1 may denote “sub 6 GHz range”, and FR2 may denote “above 6 GHz range” and may be referred to as millimeter wave (mmW).

TABLE 3

| Frequency Range | Corresponding Frequency | |
|---|---|---|
| Designation | Range | Subcarrier Spacing |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed. For example, FR1 may include a frequency band from 410 MHz to 7125 MHz, as shown in Table 4 below. That is, FR1 may include a frequency band of 6 GHz (or 5850, 5900, 5925 MHz, etc.) or higher. For example, the frequency band of 6 GHz (or 5850, 5900, 5925 MHz, etc.) or higher included in FR1 mat include an unlicensed band. The unlicensed band may be used for diverse purposes, for example, used for communication for vehicles (e.g., self-driving).

TABLE 4

| Frequency Range | Corresponding Frequency | |
|---|---|---|
| Designation | Range | Subcarrier Spacing |
| FR1 | 410 MHz-7125 MHz | 15, 30, 60 kHz |
| FR2 | 24250 MHz-52600 MHz | 60, 120, 240 kHz |

In the NR system, OFDM(A) numerology (e.g., SCS, CP length, etc.) may be differently configured between a plurality of cells merged into one UE. Hence, an (absolute time) duration of a time resource (e.g., SF, slot or TTI) (for convenience, collectively referred to as a time unit (TU)) consisting of the same number of symbols may be configured differently between the merged cells.

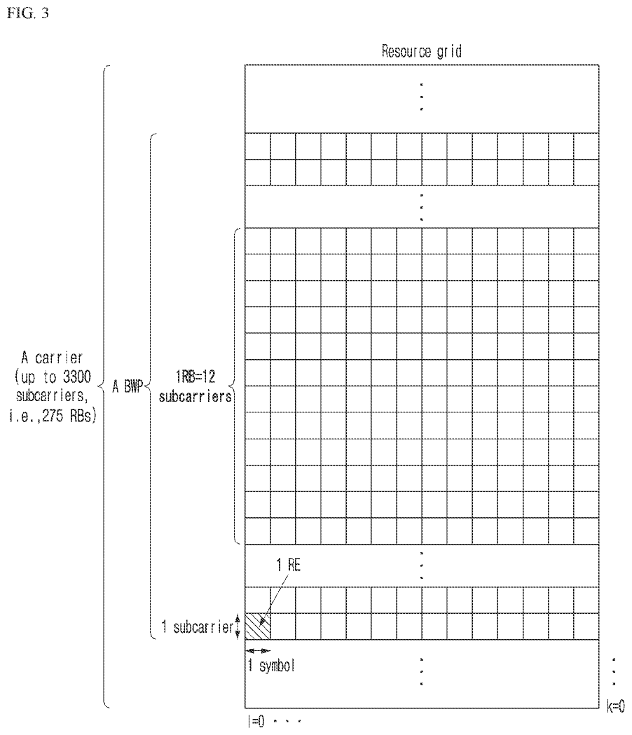

FIG. 3 illustrates an example of a slot structure used in a system applicable to the present disclosure.

A slot includes a plurality of symbols in a time domain. For example, one slot includes 7 symbols in a normal CP, while one slot includes 6 symbols in an extended CP. A carrier includes a plurality of subcarriers in a frequency domain. A resource block (RB) is defined as a plurality of (e.g., 12) consecutive subcarriers in the frequency domain. A bandwidth part (BWP) is defined as a plurality of consecutive (P)RBs in the frequency domain and may correspond to one numerology (e.g., SCS, CP length, etc.). The carrier may include up to N (e.g., 5) BWPs. The data communication may be performed through an activated BWP, and only one BWP may be activated in one UE. In a resource grid, each element is referred to as a resource element (RE), and one complex symbol may be mapped to each RE.

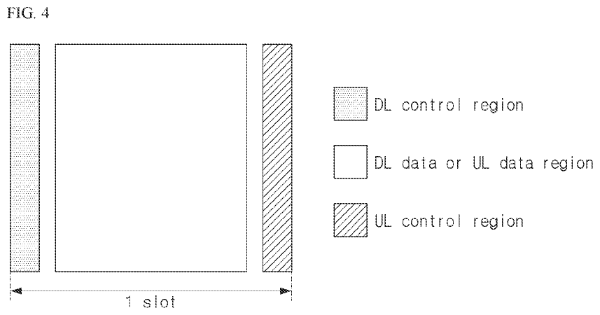

FIG. 4 illustrates an example of a slot structure of a radio frame used in a system applicable to the present disclosure.

FIG. 4 illustrates an example of a slot structure of a frame of an NR system as an example of a system.

As illustrated in an example of FIG. 4, a frame structure of NR is characterized by a self-contained structure in which DL control channel, DL or UL data, and UL control channel can all be included in a slot unit. In this instance, DL data scheduling information, UL data scheduling information, etc. may be transmitted on the DL control channel, and ACK/NACK information for DL data, CSI information (modulation and coding scheme information. MIMO transmission-related information, etc.), scheduling request, etc. may be transmitted on the UL control channel. In FIG. 4, a time gap for DL-to-UL or UL-to-DL switching may exist between a control region and a data region. In addition, some of DL control/DL data/UL data/UL control may not be configured in a slot. Or, the order of each channel configuring a slot may vary (e.g., DL control/DL data/UL control/UL data or UL control/UL data/DL control/DL data, etc.).

### Technical Terms Used in the Present Disclosure

UE: User Equipment
SSB: Synchronization Signal Block
MIB: Master Information Block
RMSI: Remaining Minimum System Information
FR1: Frequency Range 1. It refers to a frequency domain less than or equal to 6 GHz (e.g., 450 MHz to 6,000 MHz).
FR2: Frequency Range 2. It refers to a millimeter wave (mmWave) domain greater than or equal to 24 GHz (e.g., 24,250 MHz to 52,600 MHz).
BW: Bandwidth
BWP: Bandwidth Part
RNTI: Radio Network Temporary Identifier
CRC: Cyclic Redundancy Check
SIB: System Information Block
SIB1: SIB1 for NR devices=RMSI (Remaining Minimum System Information). It broadcasts information, etc. necessary for cell access of an NR UE.
CORESET (COntrol REsource SET): Time/frequency resource in which an NR UE attempts candidate PDCCH decoding
CORESET #0: CORESET for Type0-PDCCH CSS set for NR devices (configured in MIB)
Type0-PDCCH CSS set: a search space set in which an NR UE monitors a set of PDCCH candidates for a DCI format with CRC scrambled by a SI-RNTI
MO: PDCCH Monitoring Occasion for Type0-PDCCH CSS set
SIB1-R: (additional) SIB1 for reduced capability NR devices. It may be limited when it is generated in a separate TB from SIB1 and is transmitted on a separate PDSCH.
CORESET #0-R: CORESET #0 for reduced capability NR devices
Type0-PDCCH-R CSS set: a search space set in which an redcap UE monitors a set of PDCCH candidates for a DCI format with CRC scrambled by a SI-RNTI
MO-R: PDCCH Monitoring Occasion for Type0-PDCCH CSS set
Cell defining SSB (CD-SSB): SSB including RMSI scheduling information among NR SSBs
Non-cell defining SSB (non-CD-SSB): It refers to SSB that has been deployed on NR sync raster but does not include RMSI scheduling information of a corresponding cell for measurement. But, the SSB can include information informing a location of cell defining SSB.
SCS: subcarrier spacing
SI-RNTI: System Information Radio-Network Temporary Identifier
Camp on: “Camp on” is the UE state in which the UE stays on a cell and is ready to initiate a potential dedicated service or to receive an ongoing broadcast service.
TB: Transport Block
RSA (Redcap standalone): Redcap device or cell supporting only service
SIB1(-R)-PDSCH: PDSCH transmitting SIB1(-R)
SIB1(-R)-DCI: DCI scheduling SIB1(-R)-PDSCH. DCI format 1_0 with CRC scrambled by SI-RNTI.
SIB1(-R)-PDCCH: PDCCH transmitting SIB1(-R)-DCI
FDRA: Frequency Domain Resource Allocation
TDRA: Time Domain Resource Allocation
RA: Random Access
MSGA: preamble and payload transmissions of the random access procedure for 2-step RA type.
MSGB: response to MSGA in the 2-step random access procedure. MSGB may consist of response(s) for contention resolution, fallback indication(s), and backoff indication.
RO-N: RACH Occasion (RO) for normal UE 4-step RACH and 2-step RACH (if configured)
RO-N1, RO-N2: If a separate RO for normal UE 2-step RACH is configured, it is distinguished into RO-N1(4-step) and RO-N2(2-step).
RO-R: RACH Occasion (RO) configured for redcap UE 4-step RACH and 2-step RACH (if configured) separately from RO-N
RO-R1, RO-R2: If a separate RO for redcap UE 2-step RACH is configured, it is distinguished into RO-R1(4-step) and RO-R2(2-step).
PG-R: MsgA-Preambles Group for redcap UEs
RAR: Randoma Access Response
RAR window: the time window to monitor RA response(s)
FH: Frequency Hopping
iBWP: initial BWP
iBWP-DL(-UL): initial DL(UL) BWP
iBWP-DL(-UL)-R: (separate) initial DL(UL) BWP for RedCap
CS: Cyclic shift
NB: Narrowband
TO: Traffic Offloading
mMTC; massive Machine Type Communications
eMBB: enhanced Mobile Broadband Communication
URLLC: Ultra-Reliable and Low Latency Communication
RedCap: Reduced Capability
eRedCap: enhanced RedCap
FDD: Frequency Division Duplex
HD-FDD: Half-Duplex-FDD
DRX: Discontinuous Reception
RRC: Radio Resource Control
RRM: Radio Resource Management
IWSN: Industrial Wireless Sensor Network
LPWA: Low Power Wide Area
RB: Resource Block
CCE: Control Channel Element
AL: Aggregation Level
PRG: Physical Resource-block Group
DFT-s-OFDM: DFT-spread OFDM
PBCH: Physical Broadcast Channel
A-PBCH: Additional PBCH
BD: blind detection
EPRE: Energy Per RE
SNR: Signal-to-Noise Ratio
TDM: Time Division Multiplexing
DMRS: DeModulation Reference Signal
TDD: Time Division Duplex
FDM: Frequency Division Multiplexing
PRI: PUCCH Resource Indicator
SS: Search Space
RS: Reference Signal
CSI-RS: Channel State Information Reference Signal
TRS: Tracking Reference Signal (CSI-RS for tracking)

### Composition and Method of the Present Disclosure

In the present disclosure, ‘0’ can be interpreted as both when excluding content in parentheses and when including content in parentheses.

In the present disclosure, ‘/’ can be interpreted as when including all the contents separated by ‘/’ (and), or when including only a part of the separated contents.

The 5G wireless communication system is characterized by effectively supporting use cases, such as mMTC, eMBB, and URLLC, compared to the previous generation wireless communication system (e.g., LTE, GSM). Due to these advantages, the 5G wireless communication system is expected to create new use cases and gradually replace the previous generation wireless communication system for various use cases.

In particular, features of enhanced low latency, high reliability, massive connection, etc. of the 5G wireless communication system can be very advantageous for services/use cases (hereinafter, NB services/use cases) that have been supported in existing narrowband (NB) dedicated spectrum, as follows.

### Examples of Services/Use Cases to which the Present Disclosure is Applicable

Railway mobile communication
Utility/infrastructure network
Mobile communication for public safety

The NB services/use cases have been previously supported in a FDD dedicated spectrum with a bandwidth of about 3 MHz or more and less than 5 MHz in a frequency band less than 1 GHz using the previous generation wireless communication system. A method of supporting the NB services/use cases in the 5G wireless communication system in the same environment (i.e., in a bandwidth of about 3 MHz or more and less than 5 MHz in a frequency band less than 1 GHz) is considered. To this end, it may be necessary to support a channel BW less than 5 MHz in the 5G NR standard. A minimum channel BW currently supported in the 5G NR standard is 5 MHz.

### Example of 5G NR Frequency Band for NB Service/Use Case Support (TS38.101-1)

NB services/use cases can be supported, for example, in the following NR operating frequency band defined in NR standard 3GPP TS (technical standard) 38.101-1. Table 5 shows “Table 5.2-1: NR operating bands in FR1” of 3GPP TS 38.101-1.

TABLE 5

| | Uplink (UL) | Downlink (DL) | |
|---|---|---|---|
| NR | operating band | operating band | |
| operating | BS receive/UE transmit | BS transmit/UE receive | Duplex |
| band | F_{UL}_low − F_{UL}_high | F_{DL}_low − F_{DL}_high | Mode |
| n8 | 880 MHz-915 MHz | 925 MHz-960 MHz | FDD |
| n26 | 814 MHz-849 MHz | 859 MHz-894 MHz | FDD |
| n28 | 703 MHz-748 MHz | 758 MHz-803 MHz | FDD |
| n100 | 874.4 MHz-880 MHz | 919.4 MHz-925 MHz | FDD |

### Example of Definition of Channel BW of Less than 5 MHz for NB Service/Use Case Supporting

Table 6 shows an example of the maximum number of configurable RBs (N_{RB}) for each channel BW. Specifically, Table 6 shows an example of defining 3 MHz channel BW and the maximum number of configurable RBs (N_{RB}) 15 for the 3 MHz channel BW in order to support the NB services/use cases based on 5G NR, and representing a resource utilization ratio (or RU). The RU can be defined as in Equation 1 below.

$$RU = ( {N}_{RB} in MHz ) / ( channel BW in MHz ) \qquad [ Equation 1 ]$$

Table 6 below shows a support example 1 for channel BW of less than 5 MHz.

TABLE 6

| | Channel BW | | | | | | | | |
|---|---|---|---|---|---|---|---|---|---|
| | 3 | 5 | 10 | 15 | 20 | 25 | 30 | 40 | 50 |
| | MHz | MHz | MHz | MHz | MHz | MHz | MHz | MHz | MHz |
| N_{RB} | 15 | 25 | 52 | 79 | 106 | 133 | 160 | 216 | 270 |
| RU | 0.9 | 0.9 | 0.936 | 0.948 | 0.954 | 0.958 | 0.96 | 0.972 | 0.972 |

Alternatively, for newly defined 3 MHz channel BW, considering interference between contiguous channels and the resource utilization ratio, one of N_{RB} values shown in Table 7 below may be defined and used. Alternatively, multiple values of N_{RB} values shown in Table 7 below may be supported in the NR standard and supported by BS configuration.

Table 7 below shows a support example 2 for channel BW of less than 5 MHz.

TABLE 7

| | 3 MHz | | | | |
|---|---|---|---|---|---|
| SCS (kHz) | N_{RB} | N_{RB} | N_{RB} | N_{RB} | N_{RB} |
| 15 | 12 | 13 | 14 | 15 | 16 |
| RU (%) | 0.72 | 0.78 | 0.84 | 0.9 | 0.96 |

In this instance, the channel BW/N_{RB} may apply the same value for both DL and UL, or channel BW/N_{RB} may be configured/supported separately/independently for DL and UL. The latter case may be a method of selecting when intending to apply conditions where additional DFT precoding is applicable only to the UL when determining the N_{RB} values, while supporting maximum channel BW/N_{RB} values in both DL and UL, for example, considering interference between contiguous channels and the resource utilization ratio.

If a channel BW less than 5 MHz is newly supported in the NR standard, there may be a problem with the reception of existing NR common/broadcast signal/channel. For example, if an SSB transmission bandwidth exceeds a minimum channel BW newly supported, the entire SSB may not be transmitted/received.

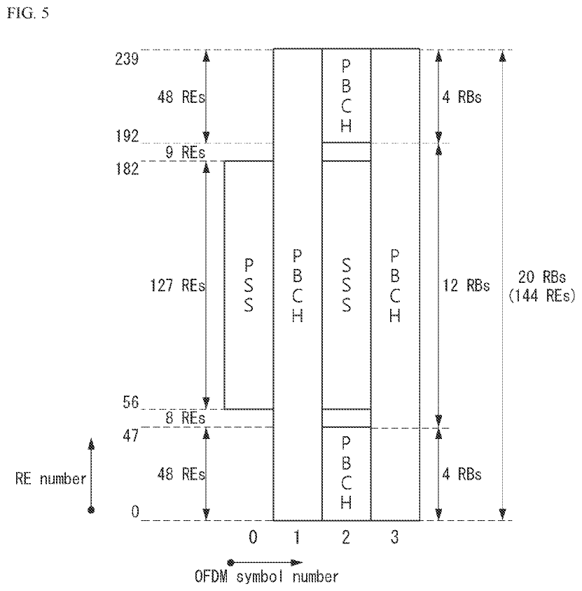

FIG. 5 illustrates an example of time/frequency structure of a synchronization signal block (SSB) in a system applicable to the present disclosure.

As shown in Tables 6 and 7. N_{RB} may be determined as one value of {12, 13, 14, 15, 16}. For example, if it is assumed that N_{RB} is 12 (12 PRBs=2.16 MHz) and SSB has 15 kHz SCS (subcarrier spacing), the transmission/reception of the entire PSS/SSS bandwidth (127 REs=1.905 MHz) is possible, but the entire transmission/reception may not be possible for PBCH (20 PRBs=3.6 MHz). In this case, the UE can normally receive the PSS/SSS (without reception coverage loss) by the UE operation defined in the existing NR standard. On the other hand, a reception coverage loss may be unavoidable for the PBCH. This may result in the overall reception coverage loss of the UE operating in a narrowband.

In order to receive SIB1-PDCCH in a narrowband, a UE may receive CORESET #0 and Type0-PDCCH CSS set information through MIB transmitted on PBCH. Since CORESET #0 bandwidth supported in the current NR standard is 24 PRBs (4.32 MHz) based on 15 kHz SCS, it may exceed narrowband channel BWs shown in Tables 6 and 7. In this instance, a base station may RE-map PDCCH transmission REs to CORESET #0 and then transmit only the REs falling within the channel BW. That is, the base station may puncture the PDCCH transmission REs exceeding the channel BW and transmit only the REs falling within the channel BW.

The CSI-RS is a type of reference signal (RS) transmitted by the base station in the DL for the purpose of DL channel sounding. The CSI-RS is used to measure characteristics of radio channel, and the base station may perform operations, such as modulation, code rate selection, and beam forming, suitable for the channel conditions based on the measurement. The UE measures the quality of DL channel using the CSI-RS and reports it to the base station by transmitting a CQI report in the UL. The base station may also configure the CSI-RS for the purpose of supporting the following operations.

Beam Management (CQI, RI, PMI Measurements): Measurements should be sent by UE to Base Stations in order to understand and estimate the correct direction of beams.

Connected Mode mobility: For calculating RSRP, RSRQ, SINR

Radio link failure detection: To check if channel is out of sync or in sync

Beam failure detection and Recovery: Based on estimation of such signals, UE can be forced to perform contention free random-access attempt (when Base Station assigns dedicated preamble)

### Time and Frequency Synchronization (Tracking Reference Signals)

### Coordination and Multi Point Transmission

The present disclosure proposes a method of configuring and supporting CSI-RS in narrowband.

In the present disclosure, narrowband and NB can be interpreted/applied interchangeably. Further, channel BW. N_{RB}, and max transmission BW can also be interpreted/applied interchangeably.

In the present disclosure, broadcast signaling includes a signaling method, etc. using system information including SIB1, MIB, a PBCH payload generated in the PHY layer in addition to the MIB, and a PBCH scrambling sequence and PBCH DMRS sequence initialization information.

### Method of Configuring CSI-RS in Narrowband

According to the 3GPP TS 38.214 standard, a minimum BW of minimum configurable CSI-RS is specified as shown in Table 8 below.

TABLE 8
The bandwidth and initial common resource block (CRB) index of a CSI-RS resource
within a BWP, as defined in Clause 7.4.1.5 of [4, TS 38.211], are determined based on the
higher layer parameters nrofRBs and startingRB, respectively, within the CSI-
FrequencyOccupation IE configured by the higher layer parameter freqBand within the
CSI-RS-ResourceMapping IE. Both nrofRBs and startingRB are configured as integer
multiples of 4 RBs, and the reference point for startingRB is CRB 0 on the common
$resource block grid . If startingRB < {N}_{BWP}^{start} , the UE shall assume that the initial CRB$
$index of the CSI - RS resource is {N}_{initial RB} = {N}_{BWP}^{start} , otherwise {N}_{initial RB} =$
$startingRB . If nrofRBs > {N}_{BWP}^{size} + {N}_{BWP}^{start} - {N}_{initial RB} , the UE shall assume that the$
$bandwidth of the CSI - RS resource is {N}_{CSI - RS}^{BW} = {N}_{BWP}^{size} + {N}_{BWP}^{start} - {N}_{initial RB} , otherwise$
${N}_{CSI - RS}^{BW} = nrofRBs . In all cases , the UE shall expect that {N}_{CSI - RS}^{BW} \geq min ( 24 , {N}_{BWP}^{size} ) .$

That is, minimum CSI-RS BW that the base station can configure is specified as min{24 PRBs, bandwidth of BWP

$${N}_{BWP}^{size} \} .$$

When configuring CSI-RS within a narrowband (especially, when NRB<24 PRBs), the base station may configure/operate the CSI-RS within the narrowband by configuring DL BWP with a size that does not exceed NRB within the narrowband. Or, if the UE does not support all BWP sizes, the following method may be used to specify the minimum CSI-RS BW (for the narrowband) and so that the UE supporting the narrowband supports a CSI-RS BW of at least the size specified below.
Method #1-1: min{24 PRBs, max Tx BW}
Method #1-2: min{24 PRBs, PBCH BW}
Method #1-3: min {24 PRBs, COREST #0 BW}

In the Method #1-2/1-3, if PBCH BW or CORESET #0 BW in the narrowband exceeds the max Tx BW and the entire PBCH BW/CORESET #0 BW cannot be used for DL transmission, the meaning of the PBCH BW/CORESET #0 BW available for actual transmission may be included. For example, if the PBCH BW/CORESET #0 BW is partially punctured and used, the PBCH BW/CORESET #0 BW in the Method #1-2/1-3 may be punctured PBCH BW/CORESET #0 BW or PBCH BW/CORESET #0 BW after puncturing.

The max Tx BW/PBCH BW/CORESET #0 BW values may be values that the UE can know in advance due to the narrowband characteristics, or may be configured/indicated to the UE by the base station via broadcast signaling. Or, an independent parameter may be defined for the purpose of limiting CSI-RS frequency resources in the narrowband, and may be configured/indicated to the UE via broadcast signaling or dedicated RRC signaling. The independent parameter for this purpose may replace the max Tx BW/PBCH BW/CORESET #0 BW of the Method #1-1/1-2/1-3. Alternatively, the current RRC configuration may only support value(s) less than 24 PRB, which can be set to a minimum of 24 PRBs (e.g., values less than the max Tx BW such as 12, 15, 16 PRBs).

In this case, the UE may not expect the CSI-RS outside the max TX BW/PBCH BW/CORESET #0 BW, depending on which of the methods is applied.

### Method of Configuring CSI-RS for RRM

For CSI-RS for RRM, the minimum CSI-RS BW that a base station can configure is 24 PRBs. There are no additional restrictions such as min {24 PRBs, bandwidth of BWP

$${N}_{BWP}^{size} \} .$$

Therefore, there is no conventional method for configuring the CSI-RS to be limited within the narrowband in configuration of the CSI-RS for RRM. To configure the CSI-RS for RRM within the narrowband (especially, when NRB<24 PRBs), the base station may configure a DL BWP with a size that does not exceed NRB within the narrowband, or may apply the Method #1-1/1-2/1-3 proposed above if the UE does not support all BWP sizes.

In this case, the UE may not expect the CSI-RS for RRM outside (initial) DL BWP/max TX BW/PBCH BW/CORESET #0 BW, depending on which of the above methods is applied.

### Method of Configuring TRS

According to the 3GPP TS 38.214 standard, the minimum BW of the minimum configurable TRS is specified as shown in Table 9 below.

TABLE 9
Each CSI-RS resource, defined in Clause 7.4.1.5.3 of [4, TS 38.211], is configured by the
higher layer parameter NZP-CSI-RS-Resource with the following restrictions:
- the time-domain locations of the two CSI-RS resources in a slot, or of the four
CSI-RS resources in two consecutive slots (which are the same across two consecutive
slots), as defined by higher layer parameter CSI-RS-resourceMapping, is given by one of
- l∈{4, 8}, l∈{5, 9}, or l∈{6, 10} for frequency range 1 and frequency range 2,
- l∈{0, 4}, l∈{5}, l∈{2, 6}, l∈{3, 7}, l∈{7, 11}, l∈{8, 12} or l∈{9, 13} for frequency
range 2.
- a single port CSI-RS resource with density ρ = 3 given by Table 7.4.1.5.3-1 from
[4, TS 38.211] and higher layer parameter density configured by CSI-RS-ResourceMapping.
$‐ if carrier {N}_{grid}^{size , μ} = 52 , {N}_{BWP , i}^{size} = 52 , μ = 0 and the carrier is configured in$
paired spectrum, the bandwidth of the CSI-RS resource, as given by the higher layer
parameter freqBand configured by CSI-RS-ResourceMapping, is X resource blocks, where
X ≥ 28 resource blocks if the UE indicates trs-AddBW-Set1 for the trs-
AdditionalBandwidth capability for CSI-RS for tracking or addBW-Set1 for the
aperiodicCSI-RS-AdditionalBandwidth capability for aperiodic CSI-RS for fast SCell
activation and X ≥ 32 if the UE indicates trs-AddBW-Set2 for the AdditionalBandwidth
capability for CSI-RS for tracking or addBW-Set2 for the aperiodicCSI-RS-
AdditionalBandwidth capability for aperiodic CSI-RS for fast SCell activation; in these
cases, if the UE is configured with CSI-RS comprising X<52 resource blocks, the UE does
not expect that the total number of PRBs allocated for DL transmissions but not overlapped
with the PRBs carrying CSI-RS for tracking is more than 4, where all CSI-RS resource
configurations shall span the same set of resource blocks; otherwise, the bandwidth of the
CSI-RS resource, as given by the higher layer parameter freqBand configured by CSI-RS-
$ResourceMapping , is the minimum of 52 and {N}_{BWP , i}^{size} resource blocks , or is equal to {N}_{BWP , i}^{size}$
resource blocks. For operation with shared spectrum channel access in FRI, freqBand
$configured by CSI - RS - ResourceMapping , is the minimum of 48 and {N}_{BWP , i}^{size} resource$
$blocks , or is equal to {N}_{BWP , i}^{size} resource blocks .$
- the UE is not expected to be configured with the periodicity of 2^{μ} × 10 slots if the
bandwidth of CSI-RS resource is larger than 52 resource blocks.
- the periodicity and slot offset for periodic NZP CSI-RS resources, as given by the
higher layer parameter periodicityAndOffset configured by NZP-CSI-RS-Resource, is one
of 2^{μ} Xₚ slots where Xₚ = 10, 20, 40, or 80 and where μ is defined in Clause 4.3 of [4, TS
38.211].
- same powerControlOffset and power ControlOffsetSS given by NZP-CSI-RS-
Resource value across all resources.

That is, minimum TRS BW that the base station can configure is specified as min {52 PRBs, bandwidth of BWP

$${N}_{BWP}^{size} \} .$$

When configuring TRS within a narrowband (especially, when NRB<24 PRBs), the base station may configure/operate the TRS within the narrowband by configuring DL BWP with a size that does not exceed NRB within the narrowband. Or, if the UE does not support all BWP sizes, the following method may be used to specify the minimum TRS BW (for the narrowband) and so that the UE supporting the narrowband supports a TRS BW of at least the size specified below.
Method #2-1: min{52 PRBs, max Tx BW}
Method #2-2: min {52 PRBs, PBCH BW}
Method #2-3: min {52 PRBs, COREST {0 BW}

In the Method #2-2/2-3, if PBCH BW or CORESET #0 BW in the narrowband exceeds the max Tx BW and the entire PBCH BW/CORESET #0 BW cannot be used for DL transmission, the meaning of the PBCH BW/CORESET #0 BW available for actual transmission may be included. For example, if the PBCH BW/CORESET #0 BW is partially punctured and used, the PBCH BW/CORESET #0 BW in the Method #2-2/2-3 may be punctured PBCH BW/CORESET #0 BW or PBCH BW/CORESET #0 BW after puncturing.

The max Tx BW/PBCH BW/CORESET #0 BW values may be values that the UE can know in advance due to the narrowband characteristics, or may be configured/indicated to the UE by the base station via broadcast signaling. Or, an independent parameter may be defined for the purpose of limiting TRS frequency resources in the narrowband, and may be configured/indicated to the UE via broadcast signaling or dedicated RRC signaling. The independent parameter for this purpose may replace the max Tx BW/PBCH BW/CORESET #0 BW of the Method #2-1/2-2/2-3. Alternatively, the current RRC configuration may only support value(s) less than 52 PRBs, which can be set to a minimum of 52 PRBs (e.g., values less than the max Tx BW such as 12, 15, 16 PRBs).

In this case, the UE may not expect the TRS outside the max TX BW/PBCH BW/CORESET #0 BW, depending on which of the methods is applied.

In order to support the CSI-RS/TRS in the narrowband, the newly supported (initial) DL BWP/max Tx BW/PBCH BW/CORESET #0 BW values, minimum CSI-RS/TRS BW setting values, etc. may be limited to being selected/configured from among multiples of a specific value when conventional UEs support BWP sizes only in multiples of a specific value in consideration of complexity. For example, when BWP size is supported in multiples of 4 PRB, they may be selected/configured from among values such as 12 PRB, 16 PRB, etc.

### Description of Claims Related to UE

Below, the above-described embodiments are described in detail from a perspective of an operation of a UE with reference to FIG. 7. Methods to be described below are merely distinguished for convenience of explanation. Thus, as long as the methods are not mutually exclusive, it is obvious that partial configuration of any method can be substituted or combined with partial configuration of another method.

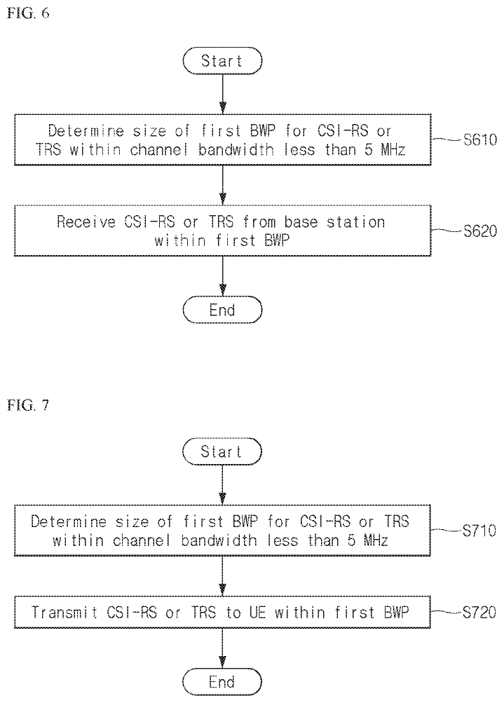

FIG. 6 illustrates an example of an operation process of a UE in a system applicable to the present disclosure.

In step S610, a UE determines a size of a first bandwidth part (BWP) for a channel state information-reference signal (CSI-RS) or a tracking reference signal (TRS) within a channel bandwidth less than 5 MHz.

For the CSI-RS, the first BWP is based on a minimum value among a maximum transmit bandwidth (max Tx BW) and 24 physical resource blocks (PRBs).

For the TRS, the first BWP is based on a minimum value among the max Tx BW and 52 PRBs.

In step S620, the UE receives the CSI-RS or the TRS from a base station (BS) within the first BWP.

According to various embodiments of the present disclosure, when the CSI-RS is related to a radio resource management (RRM), the first BWP may include less than 24 PRBs.

According to various embodiments of the present disclosure, an embodiment of FIG. 6 may further include receiving information on at least one of the max Tx BW, a physical broadcast channel (PBCH) bandwidth, or a control resource set #0 (CORESET #0) bandwidth from the base station.

According to various embodiments of the present disclosure, the size of the first BWP for the CSI-RS or the TRS may be based on a minimum value among (i) at least one of the max Tx BW, the PBCH bandwidth, or the CORESET #0 bandwidth and (ii) the 24 PRBs or the 52 PRBs.

According to various embodiments of the present disclosure, the information on the max Tx BW, the PBCH bandwidth, or the CORESET #0 bandwidth may be received via broadcast signaling or a dedicated radio resource control (RRC) signal.

According to various embodiments of the present disclosure, the size of the first BWP may be determined to be less than the channel bandwidth.

According to various embodiments of the present disclosure, if the UE supports the first BWP of any size within a dedicated spectrum less than 5 MHz, the first BWP may be configured by the base station to a size not exceeding the channel bandwidth.

According to various embodiments of the present disclosure, if the UE does not support a BWP of any size within the dedicated spectrum less than 5 MHz, for the CSI-RS, the first BWP may be based on the minimum value among the max Tx BW and the 24 PRBs, and for the TRS, the first BWP may be based on the minimum value among the max Tx BW and the 52 PRBs.

According to various embodiments of the present disclosure, there is provided a user equipment (UE) in a wireless communication system. The UE may include a transceiver and at least one processor, and the at least one processor may be configured to perform the operation method of the UE based on FIG. 6.

According to various embodiments of the present disclosure, there is provided a device controlling a user equipment (UE) in a wireless communication system. The device may include at least one processor and at least one memory operably connected to the at least one processor. The at least one memory may be configured to store instructions performing the operation method of the UE based on FIG. 6 based on being executed by the at least one processor.

According to various embodiments of the present disclosure, there are provided one or more non-transitory computer readable mediums (CRMs) storing one or more instructions. The one or more instructions may be configured to perform operations based on being executed by one or more processors, and the operations may include the operation method of the UE based on FIG. 6.

### Description of Claims Related to BSI

Below, the above-described embodiments are described in detail from a perspective of an operation of a base station with reference to FIG. 7. Methods to be described below are merely distinguished for convenience of explanation. Thus, as long as the methods are not mutually exclusive, it is obvious that partial configuration of any method can be substituted or combined with partial configuration of another method.

FIG. 7 illustrates an example of an operation process of a base station in a system applicable to the present disclosure.

In step S710, a base station determines a size of a first bandwidth part (BWP) for a channel state information reference signal (CSI-RS) or a tracking reference signal (TRS) within a channel bandwidth less than 5 MHz.

For the CSI-RS, the first BWP is based on a minimum value among a maximum transmit bandwidth (max Tx BW) and 24 physical resource blocks (PRBs).

For the TRS, the first BWP is based on a minimum value among the max Tx BW and 52 PRBs.

In step S720, the base station receives the CSI-RS or the TRS from a user equipment (UE) within the first BWP.

According to various embodiments of the present disclosure, when the CSI-RS is related to a radio resource management (RRM), the first BWP may include less than 24 PRBs.

According to various embodiments of the present disclosure, an embodiment of FIG. 7 may further include transmitting information on at least one of the max Tx BW, a physical broadcast channel (PBCH) bandwidth, or a control resource set #0 (CORESET #0) bandwidth to the UE.

According to various embodiments of the present disclosure, the size of the first BWP for the CSI-RS or the TRS may be based on a minimum value among (i) at least one of the max Tx BW, the PBCH bandwidth, or the CORESET #0 bandwidth and (ii) the 24 PRBs or the 52 PRBs.

According to various embodiments of the present disclosure, the information on the max Tx BW, the PBCH bandwidth, or the CORESET #0 bandwidth may be received via broadcast signaling or a dedicated radio resource control (RRC) signal.

According to various embodiments of the present disclosure, the size of the first BWP may be determined to be less than the channel bandwidth.

According to various embodiments of the present disclosure, if the UE supports the first BWP of any size within a dedicated spectrum less than 5 MHz, the first BWP may be configured by the base station to a size not exceeding the channel bandwidth.

According to various embodiments of the present disclosure, if the UE does not support a BWP of any size within the dedicated spectrum less than 5 MHz, for the CSI-RS, the first BWP may be based on the minimum value among the max Tx BW and the 24 PRBs, and for the TRS, the first BWP may be based on the minimum value among the max Tx BW and the 52 PRBs.

According to various embodiments of the present disclosure, there is provided a base station in a wireless communication system. The base station may include a transceiver and at least one processor, and the at least one processor may be configured to perform the operation method of the BS based on FIG. 7.

According to various embodiments of the present disclosure, there is provided a device controlling a base station in a wireless communication system. The device may include at least one processor and at least one memory operably connected to the at least one processor. The at least one memory may be configured to store instructions performing the operation method of the BS based on FIG. 7 based on being executed by the at least one processor.

According to various embodiments of the present disclosure, there are provided one or more non-transitory computer readable mediums (CRMs) storing one or more instructions. The one or more instructions may be configured to perform operations based on being executed by one or more processors, and the operations may include the operation method of the BS based on FIG. 7.

### Wireless Device Applicable to the Present Disclosure

Examples of wireless devices to which various embodiments of the present disclosure are applied are described below.

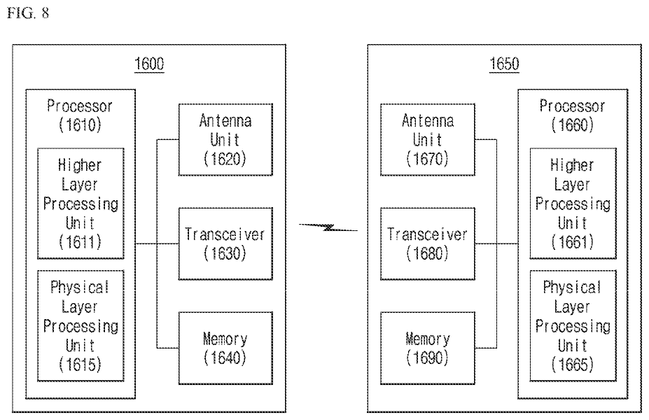

FIG. 8 illustrates an example of a structure of a first device and a second device in a system applicable to the present disclosure.

A first device 1600 may include a processor 1610, an antenna unit 1620, a transceiver 1630, and a memory 1640.

The processor 1610 may perform baseband-related signal processing and include a higher layer processing unit 1611 and a physical layer processing unit 1615. The higher layer processing unit 1611 may process operations of the MAC layer, the RRC layer, or higher layers. The physical layer processing unit 1615 may process the operation of the PHY layer. For example, if the first device 1600 is a base station (BS) device in BS-UE communication, the physical layer processing unit 1615 may perform uplink receive (Rx) signal processing, downlink transmit (Tx) signal processing, and the like. For example, if the first device 1600 is a first UE device in inter-UE communication, the physical layer processing unit 1615 may performs downlink Rx signal processing, uplink Tx signal processing, sidelink Tx signal processing, and the like. The processor 1610 may control the overall operation of the first device 1600 in addition to performing the baseband-related signal processing.

The antenna unit 1620 may include one or more physical antennas and support MIMO transmission/reception if the antenna unit 1620 includes a plurality of antennas. The transceiver 1630 may include a radio frequency (RF) transmitter and an RF receiver. The memory 1640 may store information processed by the processor 1610 and software, operating systems, and applications related to the operation of the first device 1600. The memory 1640 may also include components such as a buffer.

The processor 1610 of the first device 1600 may be configured to implement the operation of the BS in the BS-UE communication (or the operation of the first UE device in the inter-UE communication) in embodiments described in the present disclosure.

The second device 1650 may include a processor 1660, an antenna unit 1670, a transceiver 1680, and a memory 1690.

The processor 1660 may perform baseband-related signal processing and include a higher layer processing unit 1661 and a physical layer processing unit 1665. The higher layer processing unit 1661 may process the operation of the MAC layer, the RRC layer, or higher layers. The physical layer processing unit 1665 may process the operation of the PHY layer. For example, if the second device 1650 is a UE device in BS-UE communication, the physical layer processing unit 1665 may perform downlink receive (Rx) signal processing, uplink Tx signal processing, and the like. For example, if the second device 1650 is a second UE device in inter-UE communication, the physical layer processing unit 1665 may perform downlink Rx signal processing, uplink Tx signal processing, sidelink Rx signal processing, and the like. The processor 1660 may control the overall operation of the second device 1660 in addition to performing the baseband-related signal processing.

The antenna unit 1670 may include one or more physical antennas and support MIMO transmission/reception if the antenna unit 1670 includes a plurality of antennas. The transceiver 1680 may include an RF transmitter and an RF receiver, the memory 1690 may store information processed by the processor 1660 and software, operating systems, and applications related to the operation of the second device 1650. The memory 1690 may also include components such as a buffer.

The processor 1660 of the second device 1650 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 1600 and the second device 1650, and redundant descriptions are omitted.

Here, the wireless communication technology implemented in the devices 1600 and 1650 according to the present disclosure may include other various wireless communication technologies in addition to LTE, NR, and 60.

The claims described in various embodiments of the present disclosure can be combined in various ways. For example, technical features of the method claims of various embodiments of the present disclosure can be combined and implemented as a device, and technical features of the device claims of various embodiments of the present disclosure can be combined and implemented as a method. In addition, the technical features of the method claims and the technical features of the device claims in various embodiments of the present disclosure can be combined and implemented as a device, and the technical features of the method claims and the technical features of the device claims in various embodiments of the present disclosure can be combined and implemented as a method.

1. A method of operating a user equipment (UE) in a wireless communication system, the method comprising:
determining a size of a first bandwidth part (BWP) for a channel state information reference signal (CSI-RS) or a tracking reference signal (TRS) within a channel bandwidth less than 5 MHz,
wherein for the CSI-RS, the first BWP is based on a minimum value among a maximum transmit bandwidth (max Tx BW) and 24 physical resource blocks (PRBs),
wherein for the TRS, the first BWP is based on a minimum value among the max Tx BW and 52 PRBs; and
receiving the CSI-RS or the TRS from a base station (BS) within the first BWP.

2. The method of claim 1, wherein based on the CSI-RS being related to a radio resource management (RRM), the first BWP includes less than 24 PRBs.

3. The method of claim 1, further comprising:
receiving, from the base station, information on at least one of the max Tx BW, a physical broadcast channel (PBCH) bandwidth, or a control resource set #0 (CORESET #0) bandwidth.

4. The method of claim 3, wherein the size of the first BWP for the CSI-RS or the TRS is based on a minimum value among (i) at least one of the max Tx BW, the PBCH bandwidth, or the CORESET #0 bandwidth and (ii) the 24 PRBs or the 52 PRBs.

5. The method of claim 3, wherein the information on the max Tx BW, the PBCH bandwidth, or the CORESET #0 bandwidth is received via a broadcast signaling or a dedicated radio resource control (RRC) signal.

6. The method of claim 1, wherein the size of the first BWP is determined to be less than the channel bandwidth.

7. The method of claim 1, wherein based on that the UE supports the first BWP of any size within a dedicated spectrum less than 5 MHz, the first BWP is configured by the base station to a size not exceeding the channel bandwidth, and
wherein based on that the UE does not support a BWP of any size within the dedicated spectrum less than 5 MHz:
for the CSI-RS, the first BWP is based on the minimum value among the max Tx BW and the 24 PRBs, and
for the TRS, the first BWP is based on the minimum value among the max Tx BW and the 52 PRBs.

8. A method of operating a base station in a wireless communication system, the method comprising:
determining a size of a first bandwidth part (BWP) for a channel state information reference signal (CSI-RS) or a tracking reference signal (TRS) within a channel bandwidth less than 5 MHz,
wherein for the CSI-RS, the first BWP is based on a minimum value among a maximum transmit bandwidth (max Tx BW) and 24 physical resource blocks (PRBs),
wherein for the TRS, the first BWP is based on a minimum value among the max Tx BW and 52 PRBs; and
transmitting the CSI-RS or the TRS to a user equipment (UE) within the first BWP.

9. The method of claim 8, wherein based on the CSI-RS being related to a radio resource management (RRM), the first BWP includes less than 24 PRBs.

10. The method of claim 8, further comprising:
transmitting, to the UE, information on at least one of the max Tx BW, a physical broadcast channel (PBCH) bandwidth, or a control resource set #0 (CORESET #0) bandwidth.

11. The method of claim 10, wherein the size of the first BWP for the CSI-RS or the TRS is based on a minimum value among (i) at least one of the max Tx BW, the PBCH bandwidth, or the CORESET #0 bandwidth and (ii) the 24 PRBs or the 52 PRBs.

12. The method of claim 10, wherein the information on the max Tx BW, the PBCH bandwidth, or the CORESET #0 bandwidth is received via a broadcast signaling or a dedicated radio resource control (RRC) signal.

13. The method of claim 8, wherein the size of the first BWP is determined to be less than the channel bandwidth.

14. The method of claim 8, wherein based on that the UE supports the first BWP of any size within a dedicated spectrum less than 5 MHz, the first BWP is configured by the base station to a size not exceeding the channel bandwidth, and
wherein based on that the UE does not support a BWP of any size within the dedicated spectrum less than 5 MHz:
for the CSI-RS, the first BWP is based on the minimum value among the max Tx BW and the 24 PRBs, and
for the TRS, the first BWP is based on the minimum value among the max Tx BW and the 52 PRBs.

15. A user equipment (UE) in a wireless communication system, the UE comprising:
a transceiver;
at least one processor; and
at least one memory operably connectable to the at least one processor and storing instructions performing operations based on being executed by the at least one processor,
wherein the operations comprise:
determining a size of a first bandwidth part (BWP) for a channel state information reference signal (CSI-RS) or a tracking reference signal (TRS) within a channel bandwidth less than 5 MHz,
wherein for the CSI-RS, the first BWP is based on a minimum value among a maximum transmit bandwidth (max Tx BW) and 24 physical resource blocks (PRBs),
wherein for the TRS, the first BWP is based on a minimum value among the max Tx BW and 52 PRBs; and
receiving the CSI-RS or the TRS from a base station (BS) within the first BWP.

16-20. (canceled)
